(19) United States
(12) Patent Application Publication
(10) Pub. No.: US 2003/0029480 A1
(43) Pub. Date: Feb. 13, 2003

(54) Device for treating substrates

(76) Inventors: Wolfgang Marschner, Freiberg (DE); Uwe Muller, Dresden (DE)

Correspondence Address: Robert W Becker & Associates, 707 Highway 66 East Suite B, Tijeras, NM, 87059, US

(21) Appl. No.: 10/169,060

(22) PCT Filed: Dec. 2, 2000
(86) PCT No.: PCT/EP00/12145

(30) Foreign Application Priority Data
Dec. 22, 1999 (DE) 199 62 169.1

(51) Int. Cl. B08B 3/00

(52) U.S. Cl. 134/95.1; 134/113; 134/902

(57) ABSTRACT

The aim of the invention is to provide a simple and economical device for opening and closing separate suction openings (13, 14, 15) of a device (1) which is provided for treating substrates, especially semiconductor wafers, and which comprises a treatment reservoir (3). Said treatment reservoir is filled with a treatment fluid and is arranged in an essentially closed space that has at least two separate suction openings (13, 14, 15). To this end, a rotatable disc (17) is provided which covers up the suction opening while isolating it from the space and which comprises a through-opening (18). One of the suction openings (13, 14, 15) can be at least partially overlapped by said through-opening.

The present invention relates to an apparatus for the treatment of substrates, especially semiconductor wafers, with a treatment tank that can be filled with different treatment fluids, and which is disposed in an essentially closed chamber that is provided with at least two gas suction openings that are separated from one another.

During manufacture processes, especially in the semiconductor industry, it is necessary to treat substrates with different treatment fluids. For such a treatment, so-called individual treatment tanks, or Single Tank Tools (STT), were developed in which semiconductor wafers, within the same treatment tank, were successively subjected to different treatment fluids. The successive treatment of substrates in a single treatment tank has the advantage that the substrates do not have to be moved between the treatment steps.

One example of this is a treatment of a semiconductor wafer with a mixture of ammonia, hydrogen peroxide and water (SC1), followed by a treatment step in diluted hydrofluoric acid (DHF), and a subsequent rinsing step in deionized water (DIW). During the respective treatment steps, there result at least during the SC1 step and the DHF step gases that are harmful to the environment and must be separately removed or disposed of. For this reason, in such apparatus at least two separate suction openings are provided that are respectively opened and closed via a valve associated therewith in order to enable a diversified suctioning-off of gases out of a housing of the STT. In addition to the aforementioned valves for the opening and closing of the suction openings, individual trimming flaps are furthermore provided in order to control the quantity of gas suctioned off by the openings.

The provision of the individual valves, as well as their control, is very complicated and is therefore connected with high costs. The drives for the respective valves are disposed in the housing of the STT and are therefore subjected to the in part aggressive gases and are inclined to fail prematurely. Furthermore, access to the valves and their drive means is difficult, since they are disposed in the housing, which on the one hand must be kept clean from any contamination, and on the other hand provides very confined chambers in order to save space.

DE-A-196 14 653 shows a valve with a housing that is provided with at least one inlet and at least two discharge openings. Provided in the housing is a fixedly held disk as a valve seat, and as a rotary slide a disk that is mounted on the fixed disk and is rotatable via an actuating spindle, whereby formed in both of the disks are through-openings that in every position of the rotatable disk enable a medium to pass through.

DE-A-196 02 106 discloses a rotary disk valve for the control of a fluid stream, with the valve being provided with a first disk, which is fixedly mounted in a housing and is provided with through-flow openings, and a second disk that is rotatably mounted in the housing, rests against the first disk, and is provided with through-flow openings. In a first position, the through-flow openings are disposed across from one another and release the fluid stream, while in a second position the through-flow openings are offset relative to one another and block the fluid stream.

DE-C-4220070 describes a rotary disk segmented valve for the control of the through-flow quantity of a liquid or gaseous medium, according to which two disks that are provided with through-flow openings are disposed in a housing to be rotatable relative to one another such that the through-flow openings of both of the disks are opposite one another in a first position and in the second position are offset relative to one another. Downstream of the valve the through-flow openings are again joined together in order to provide a common flow. A separation of the media streams is not effected.

DE-U-8107540 provides a multipath valve having an inlet and at least two outlets, whereby a valve is provided with a rotatable disk having a through-opening that can overlap with a through-opening of a stationary part in order to convey a medium that is present at the inlet end of the valve into different through-openings.

DE-C195 26 886 shows an apparatus and a method for the reformation of methanol, according to which the effective length and/or the effective inlet cross section of a reaction chamber section that is on the input side and is tempered for high methanol conversion can, as a function of the throughput, be adjusted to the gas mixture that is to be reformed. The adjustment is effected via a rotatable disk having a through-opening that can be overlapped with one or more inlet openings of the reaction conduits. In this connection, methanol is respectively produced at the input end of the apparatus and is distributed to one or more of the reaction chambers. At the end of the reaction chambers, the methanol streams are again joined together.

Proceeding form the aforementioned apparatus for the treatment of substrates, it is an object of the present invention to provide a simplified and economical apparatus for the opening and closing of separate gas suction openings.

Pursuant to the invention, this object is realized with an apparatus of the aforementioned type by a rotatable disk for covering the gas suction openings and that has a through-opening by means of which one of the gas suction openings can be at least partially overlapped as a function of the treatment fluid that is used. In so doing, a simple switching-over between the suction openings is made possible with only a single disk and a single drive means. The disk, in a very space-saving manner, can be accommodated within the chamber, thereby reducing the space required. Furthermore, the gases released by the treatment fluid that is used can be removed separately from other gases released by other treatment fluids.

Pursuant to one preferred embodiment of the invention, at least one sealing element is provided between the disk and a wall portion of the chamber, and surrounds at least one suction opening in order to provide a good seal of the chamber atmosphere relative to the suction openings. In this connection, the sealing element is preferably a PTFE ring that in addition to the sealing effect ensures a good sliding movement of the disk relative to the ring during a rotational movement of the disk.

In order to protect the drive means for rotating the disk from the in part aggressive atmosphere in the chamber, the drive means is preferably disposed on a side of the disk that faces away from the chamber. Furthermore, this facilitates access to the drive means, since it is accessible from the outside. In this connection, the drive apparatus is preferably provided with at least one sensor for detecting the rotational position of the disk in order to enable a precise adjustment of the rotational position. Just like the drive apparatus, the sensor is disposed beyond the chemically aggressive atmosphere and is also easily accessible from the outside.

To enable a trimming by varying the amount of overlap between through-opening and suction opening, a control device for the control of the rotational position of the disk is preferably provided. In this connection, the degree of overlap for a precise trimming is preferably controllable as a function of the suction pressure.

For a good adjustment of the degree of overlap between through-opening and suction opening, the through-opening preferably has a shape that tapers in the direction of rotation. In this way, the degree of overlap can be adjusted very precisely, especially at the beginning of the overlap.

The apparatus preferably has three annularly arranged suction openings. Pursuant to a particularly preferred embodiment of the invention, the suction openings are disposed below the treatment tank.

The invention will be explained in greater detail subsequently with the aid of a preferred embodiment with reference to the drawings; the drawings show:

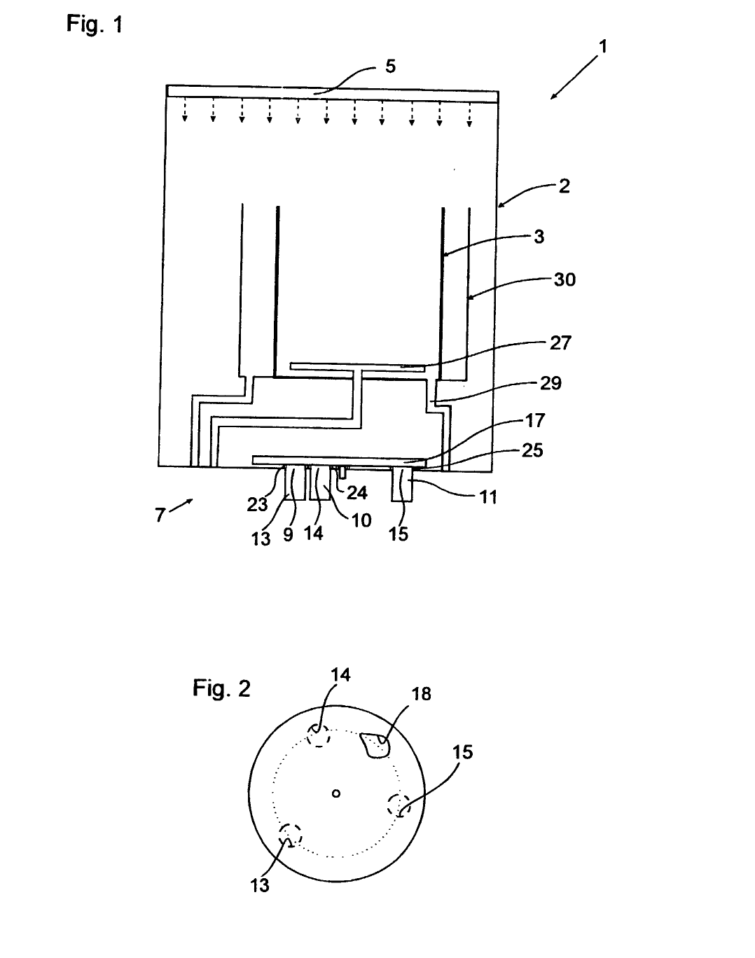

FIG. 1 a schematic cross-sectional view through one inventive apparatus for the treatment of substrates;

FIG. 2 a schematic plan view upon a rotatable disk for the communication of a chamber of the treatment apparatus with various suction openings; and

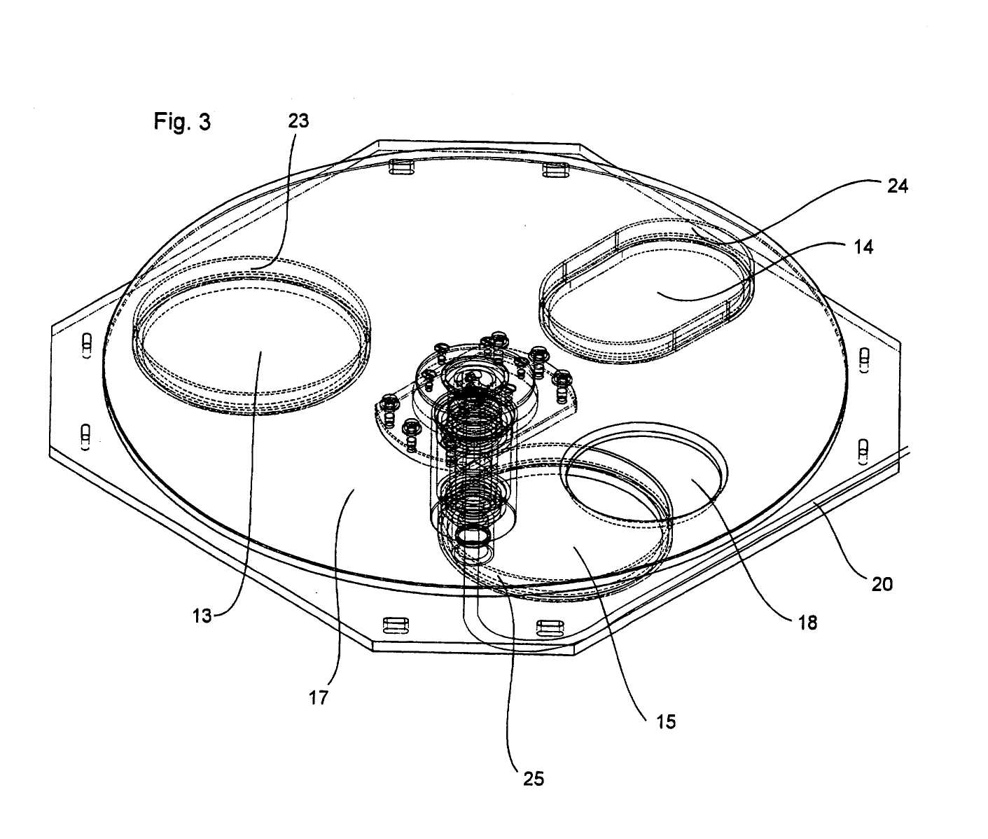

FIG. 3 a perspective view of the disk and the suction openings pursuant to an alternative embodiment of the invention.

In FIGS. 1 to 3, the same reference numerals are used for the same or equivalent elements.

FIG. 1 shows an apparatus 1 for the wet treatment of semiconductor wafers, with a closed housing 2 as well as a treatment tank 3 disposed therein. The housing 2 is provided with suitable, non-illustrated introduction/output or distribution transfer mechanisms for the semiconductor wafers.

Provided on an upper wall of the housing 2 is a gas diffusor 5 having a plurality of downwardly directed nozzles in order to generate a downwardly directed gas flow in the housing 2. In this connection, the flow discharged from the diffusor 5 is laminar. A suction device 7 is provided at the bottom of the housing 2. The suction device 7 has three separate withdrawal lines 9,10,11 that are connected to the housing 2 and that via openings 13,14,15 are in communication with the interior of the housing 2. The lines 9,10,11 are respectively connected to a vacuum source, such as, for example, a vacuum pump, in order to suction off the gas atmosphere that is in the housing 2. Each of the lines 9,10 and 11 is connected to a different removal unit for the suctioned-off gas, as will be explained in greater detail subsequently.

Disposed within the housing 2 is a rotatable disk 17 for covering the openings 13,14,15; the disk has a through-opening 18, which can be seen best in FIG. 2. The opening 18 has an essentially round main shape that tapers in a direction of rotation of the disk 17. In the embodiment of FIG. 3, the opening 18 has a round shape without any tapering. The rotatable disk 17 is connected via a flexible drive shaft 20, which can be seen best in FIG. 3, with a drive unit, such as, for example, a servo-motor, which is not illustrated in detail. The rotatable drive shaft 20 extends through the bottom of the housing 2 and is centrally connected to a downwardly directed side of the disk 17.

Provided between the rotatable disk 17 and the bottom of the housing 2 are sealing elements, such as, for example, PTFE rings 23, 24,25 that surround the openings 13,14,15 and upon which the disk 17 rests. The PTFE rings seal the respective lines 9,10,11 from one another as well as relative to the gas atmosphere in the housing 2. They furthermore provide a slide surface for the rotatable disk 17. In the same manner, a sealing element, such as, for example, a PTFE ring, surrounds the flexible shaft 20 in the region between the bottom of the housing 2 and the rotatable disk 17 in order to protect the shaft from the gas atmosphere in the housing 2. The apparatus 1 has a cleaning device, which is not illustrated in detail, for the rotatable disk, as well as the elements, such as, for example, the sealing elements, that are connected therewith.

The treatment tank 3 can be filled via a diffusor 27, that is connected to an appropriate line 28, with, various treatment fluids, such as, for example, SC1, hydrofluoric acid DHF, and deionized water. The treatment tank 3 is furthermore provided with a discharge line 29 for the discharge of the treatment fluid.

The treatment tank 3 is surrounded by an overflow 30, which is provided with a discharge line 32.

For the treatment of the semiconductor wafers, they are first introduced into the housing 2 via the non-illustrated introduction/distribution transfer mechanism. Subsequently, the wafers are placed via a non-illustrated handling device into the treatment tank 3, and are held therein by a non-illustrated holding device.

Treatment fluid, such as, for example, SC1, is subsequently introduced into the treatment tank 3 via the diffusor 27 and is caused to overflow out of the treatment tank 3, so that it flows into the overflow 30. After a certain processing time, the SC1 chemical is rapidly withdrawn out of the treatment tank 3 via the line 29, and subsequently hydrofluoric acid (DHF) is introduced into the treatment tank 3 until it flows out of the treatment tank 3 into the overflow 30. This flow is maintained for a certain processing time, and the hydrofluoric acid is subsequently similarly discharged via the line 29.

The treatment tank 3 is subsequently filled with deionized water, which also flows into the overflow 30, in order to rinse the wafers that are located in the tank 3. The thus rinsed wafers are then removed from the tank 3 via the non-illustrated handling device, are dried in a suitable manner, and are transported out of the housing 2.

During the entire process described above, a downwardly directed gas flow, for example an air flow, is generated via the diffusor 5, whereby the air is again suctioned off at the bottom of the housing 2 via the suction device 7. In this connection, as a function of the treatment process that is respectively taking place in the treatment tank 3, a respective one of the lines 9,10,11 is connected with the interior of the housing 2.

During the insertion of the wafers, as well as during the step of rinsing the wafers with deionized water, the opening 18 in the rotary disk 17 is disposed over the opening 14 in the bottom of the housing 2. There is thus effected a suctioning-off of the air that is in the housing 2 via the line 10. Since during the insertion and the rinsing step no dangerous gases are produced, the suctioned-off air can be expelled essentially untreated into the atmosphere.

For the SC1 treatment, the opening 18 in the disk 17 is moved over the opening 13 in order to suction off air found in the housing 2 via the line 9. Acid-containing gases are produced that are environmentally harmful and that cannot simply be expelled into the atmosphere. These gases are suctioned-off with the air stream via the line 9 and are treated in a suitable manner.

During the treatment with hydrofluoric acid, the opening 18 in the disk 17 is disposed over the opening 15 in the bottom of the housing 2, so that a suctioning-off is effected via the line 11. During the treatment with hydrofluoric acid environmentally harmful gases are again produced; however, these gases differ from those produced during the SC1 treatment, and must be disposed of in a different manner.

The degree of overlap of the opening 18 over the respective openings 13,14,15 in the bottom of the housing 2 is controlled as a function of the vacuum that exists in the respective lines 9,10,11 as well as of the desired amount of withdrawal. Due to the shape of the opening 18, which tapers in the direction of rotation, a fine control of the magnitude of overlap is possible. For a good position control, there is provided in the region of the flexible shaft 20 a position-detection sensor that transfers the position to a control unit that in conformity therewith controls the drive motor.

Although the present invention was described with the aid of a preferred embodiment, it is not limited to this special embodiment. In particular, it is possible to provide different treatment chemicals as well as a different number of treatment steps. In this connection, it is, of course, also possible to provide a different number of suction openings and suction lines. The suction device need also not be provided at the bottom of the housing 2; rather, it is also possible to provide it on the side walls or on the upper wall of the housing 2. The shapes of the essentially round suction openings can differ from those illustrated. For example, angular shapes can also be provided. By using an absolute value emitter at the motor, the necessity for a sensor for determining the rotational position of the motor or of the rotary disk is eliminated.

1. Apparatus (1) for the treatment of substrates, especially semiconductor wafers, with a treatment tank (3) that can be filled with different treatment fluids and that is disposed in an essentially closed chamber that is provided with at least two gas suction openings (13,14,15) that are separated from one another, characterized by a rotatable disk (17) for covering the gas suction openings (13,14,15), with the disk having a through-opening (18) with which, as a function of the treatment fluid that is used, one of the gas suction openings can be at least partially overlapped.

2. Apparatus (1) according to claim 1, characterized by at least one sealing element (23,24,25) between the disk (17) and a wall portion of the chamber, with the sealing element surrounding at least one suction opening (13,14,15).

3. Apparatus (1) according to claim 1 or 2, characterized in that the sealing element (23,24, 25) is a PTFE ring.

4. Apparatus (1) according to one of the preceding claims, characterized by a drive apparatus that is disposed on a side of the disk (17) that faces away from the chamber.

5. Apparatus (1) according to one of the preceding claims, characterized in that the drive apparatus is provided with at least one sensor for the detection of the rotational position of the disk (17)

6. Apparatus (1) according to one of the preceding claims, characterized by a control device for the control of the rotational position of the disk (17) and/or of the degree of overlap between through-opening and suction opening.

7. Apparatus (1) according to claim 6, characterized in that the degree of overlap is controllable as a function of the suction pressure.

8. Apparatus (1) according to one of the preceding claims, characterized in that the through-opening 18 has a shape that tapers in the direction of rotation.

9. Apparatus (1) according to one of the preceding claims, characterized by three annularly disposed suction openings (13,14,15).

10. Apparatus (1) according to one of the preceding claims, characterized in that the suction openings are disposed below the treatment tank.
